(19) United States
(12) Patent Application Publication
(10) Pub. No.: US 2026/0168124 A1
(43) Pub. Date: Jun. 18, 2026

(54) ELECTROLYTIC COPPER FOIL, MANUFACTURING METHOD THEREOF AND CURRENT COLLECTOR

(71) Applicant: NAN YA PLASTICS CORPORATION, Taipei City (TW)

(72) Inventors: Ching-Yao Yuan, Taipei City (TW); Wei-Sheng Cheng, Taipei City (TW); Wen Ta Cheng, Taipei City (TW); Nei-Mei Fang, Taipei City (TW)

(73) Assignee: NAN YA PLASTICS CORPORATION, Taipei City (TW)

(21) Appl. No.: 19/017,737

(22) Filed: Jan. 12, 2025

(30) Foreign Application Priority Data
Dec. 17, 2024 (TW) 113149086

(51) Int. Cl. C25D 3/38; C25D 1/04; H01M 4/66

(52) U.S. Cl. CPC C25D 3/38; C25D 1/04; H01M 4/661

(57) ABSTRACT

A manufacturing method of an electrolyte copper foil is provided. The manufacturing method of an electrolyte copper foil includes: providing an electrolytic device including a cathode and an anode; soaking the cathode in an electrolyte; adding an additive into the electrolyte; and performing electroplating to form an electrolytic copper foil on a surface of the cathode. The additive includes hydroxyethyl cellulose, sodium 3-mercapto-1-propanesulfonate, ethylene thiourea, bio-glue, polyethyleneimine or a combination thereof. An electrolyte copper foil and a current collector are also provided.

### CROSS-REFERENCE TO RELATED APPLICATION

This application claims the priority benefit of Taiwan application serial no. 113149086, filed on Dec. 17, 2024. The entirety of the above-mentioned patent application is hereby incorporated by reference herein and made a part of this specification.

### BACKGROUND

### Technical Field

The present invention relates to an electrolytic copper foil, and particularly relates to an electrolytic copper foil, a manufacturing method thereof, and a current collector.

### Description of Related Art

In energy storage elements, lithium-ion secondary batteries have attracted considerable attention due to their characteristics such as rechargeable capability and high energy density. As the demand for lightweight lithium-ion batteries increases, the thickness of their internal components is also required to be reduced accordingly. However, the mechanical strength of existing internal components (such as copper foil) decreases after undergoing high-temperature processes, which easily leads to cracks on the components, thereby affecting the stability, safety, and performance of lithium-ion batteries.

### SUMMARY

The present invention provides an electrolytic copper foil that may maintain good high strength and elongation after high-temperature treatment, a manufacturing method thereof, and a current collector.

A manufacturing method of an electrolytic copper foil of the present invention includes: providing an electrolytic device including a cathode and an anode; soaking the cathode in an electrolyte; adding an additive into the electrolyte; and performing electroplating to form an electrolytic copper foil on a surface of the cathode. The additive includes hydroxyethyl cellulose, sodium 3-mercapto-1-propanesulfonate, ethylene thiourea, bio-glue, polyethyleneimine or a combination thereof. The present invention also provides an electrolytic copper foil and a current collector.

In one embodiment of the present invention, in the electrolyte, a concentration of the additive is 1 ppm to 25 ppm.

In one embodiment of the present invention, in the electrolyte, a concentration of hydroxyethyl cellulose is 1 ppm to 10 ppm, a concentration of sodium 3-mercapto-1-propanesulfonate is 1 ppm to 10 ppm, a concentration of ethylene thiourea is 1 ppm to 10 ppm, a concentration of bio-glue is 1 ppm to 10 ppm, and a concentration of polyethyleneimine is 1 ppm to 10 ppm.

In one embodiment of the present invention, the electrolyte is a copper sulfate plating solution. A concentration of copper ions in the copper sulfate plating solution is 60 g/L to 80 g/L, a concentration of sulfuric acid is 60 g/L to 110 g/L.

In one embodiment of the present invention, the copper sulfate plating solution further includes chloride ions with a concentration of 5 ppm to 30 ppm.

In an implement of the present invention, the cathode is a titanium wheel. The anode is iridium titanium oxide (IrO₂/Ti). A rotation speed of the titanium wheel is 500 rpm to 1000 rpm.

In one embodiment of the present invention, the electroplating is performed under the following conditions: a plating solution temperature is 50° C. to 70° C., a current density is 40 ASD to 60 ASD.

An electrolytic copper foil of the present invention is manufactured by the manufacturing method of an electrolytic copper foil above.

In one embodiment of the present invention, a thickness of the electrolytic copper foil is 3 μm to 8 μm.

In one embodiment of the present invention, a roughness of the electrolytic copper foil is 1.4 μm to 4.3 μm.

In one embodiment of the present invention, after heat treatment at 180° C. to 200° C. for 1 hour to 2 hours, a tensile strength of the electrolytic copper foil is 34 kg/mm² to 58 kg/mm², an elongation of the electrolytic copper foil is 3.3% to 4.2%.

A current collector of the present invention includes the electrolytic copper foil above.

Based on the above, the manufacturing method of an electrolytic copper foil of the present invention includes adding an additive into the electrolyte soaking the cathode, and the additive includes hydroxyethyl cellulose, sodium 3-mercapto-1-propanesulfonate, ethylene thiourea, bio-glue, polyethyleneimine or a combination thereof. Thus, an electrolytic copper foil that maintains good high strength and elongation even after high-temperature treatment may be produced, thereby suitable for a current collector.

In order to make the features and advantages of the invention more obvious and understandable, examples are given below for detailed description.

### DESCRIPTION OF THE EMBODIMENTS

The following are examples that describe the content of the invention in detail. The implementation details provided in the embodiments are for illustrative purposes and are not intended to limit the scope of protection of the invention. Anyone with ordinary knowledge in the art may modify or change these implementation details according to the needs of the actual implementation.

A range herein may be expressed as from “about” one specific value to “about” another specific value, and it may also be expressed directly as one specific value and/or to another specific value. In expressing ranges, another embodiment includes from the one particular value and/or to another particular value. Similarly, when a value is expressed as an approximation by use of the antecedent “about,” it will be understood that the particular value forms another embodiment. It will be further understood that the endpoints of each range are clearly related or independent of the other endpoints.

Herein, non-limiting terms (such as: may, can, for example or other similar terms) refer to unessential or optional implementation, inclusion, addition or existence.

Unless otherwise defined, all terms (including technical and scientific terms) used herein have the same meaning as commonly understood by those with ordinary knowledge in the art. It will also be understood that terms (such as those defined in commonly used dictionaries) shall be construed to have a meaning consistent with their meaning in the relevant technical context and shall not be construed in an idealized or overly formal sense, except expressly so defined herein.

The present invention provides a manufacturing method of an electrolytic copper foil including: providing an electrolytic device including a cathode and an anode; soaking the cathode in an electrolyte; adding an additive into the electrolyte; and performing electroplating to form an electrolytic copper foil on a surface of the cathode.

The cathode is not particularly limited, and suitable cathode may be selected according to needs. In this embodiment, the cathode may be a titanium wheel or other suitable cathode. The cathode may be at least partially soaked in an electrolyte. For example, when the cathode is a titanium wheel, the titanium wheel may be at least partially soaked in the electrolyte while rotating simultaneously. A rotation speed of the titanium wheel may be about 500 rpm to about 1000 rpm (exemplified by 500 rpm, 600 rpm, 700 rpm, 800 rpm, 900 rpm, 1000 rpm or any value within the aforementioned range of 500 rpm to 1000 rpm), preferably about 600 rpm to about 800 rpm.

The anode is not particularly limited, and suitable anode may be selected according to needs. In this embodiment, the anode may be iridium titanium oxide (IrO₂/Ti) or other suitable anode.

The electrolyte is not particularly limited, and suitable electrolyte may be selected according to needs. In this embodiment, the electrolyte may be a copper sulfate plating solution or other suitable electrolyte. A concentration of copper ions in the copper sulfate plating solution may be about 60 g/L to about 80 g/L (exemplified by 60 g/L, 65 g/L, 70 g/L, 75 g/L, 80 g/L or any value within the aforementioned range of 60 g/L to 80 g/L), preferably about 60 g/L to about 75 g/L; a concentration of sulfuric acid is about 60 g/L to about 110 g/L (exemplified by 60 g/L, 65 g/L, 70 g/L, 75 g/L, 80 g/L, 85 g/L, 90 g/L, 95 g/L, 100 g/L, 105 g/L, 110 g/L or any value within the aforementioned range of 60 g/L to 110 g/L), preferably about 80 g/L to about 100 g/L. The copper sulfate plating solution may further include chloride ions. A concentration of chloride ions may be about 5 ppm to about 30 ppm (exemplified by 5 ppm, 10 ppm, 15 ppm, 20 ppm, 25 ppm, 30 ppm or any value within the aforementioned range of 5 ppm to 30 ppm), preferably about 10 ppm to about 30 ppm. When the copper sulfate plating solution further includes chloride ions, it may enable the electrolytic copper foil manufactured by the manufacturing method of an electrolytic copper foil to have good roughness.

The additive includes hydroxyethyl cellulose (HEC), sodium 3-mercapto-1-propanesulfonate (MPS), ethylene thiourea (ETU), bio-glue, polyethyleneimine (PEI) or a combination thereof. The additive may include one of the aforementioned specific additives, preferably including two or more of the aforementioned specific additives. In this embodiment, the additive preferably includes sodium 3-mercapto-1-propanesulfonate and at least one selected from the group consisting of: hydroxyethyl cellulose, ethylene thiourea, bio-glue and polyethyleneimine; more preferably includes sodium 3-mercapto-1-propanesulfonate, ethylene thiourea and at least one selected from the group consisting of: hydroxyethyl cellulose, bio-glue and polyethyleneimine.

In the electrolyte, a concentration of the additive is about 1 ppm to about 25 ppm (exemplified as 1 ppm, 3 ppm, 5 ppm, 7 ppm, 9 ppm, 10 ppm, 15 ppm, 20 ppm, 25 ppm or any value within the aforementioned 1 ppm to 25 ppm), preferably about 12 ppm to about 23 ppm. In the electrolyte, a concentration of hydroxyethyl cellulose is about 1 ppm to about 10 ppm (exemplified as 1 ppm, 2 ppm, 4 ppm, 6 ppm, 8 ppm, 10 ppm or any value within the aforementioned 1 ppm to 10 ppm), preferably about 4 ppm to about 6 ppm; a concentration of sodium 3-mercapto-1-propanesulfonate is about 1 ppm to about 10 ppm (exemplified as 1 ppm, 2 ppm, 4 ppm, 6 ppm, 8 ppm, 10 ppm or any value within the aforementioned 1 ppm to 10 ppm), preferably about 2 ppm to about 6 ppm; a concentration of ethylene thiourea is about 1 ppm to about 10 ppm (exemplified as 1 ppm, 2 ppm, 4 ppm, 6 ppm, 8 ppm, 10 ppm or any value within the aforementioned 1 ppm to 10 ppm), preferably about 3 ppm to about 5 ppm; a concentration of bio-glue is about 1 ppm to about 10 ppm (exemplified as 1 ppm, 2 ppm, 4 ppm, 6 ppm, 8 ppm, 10 ppm or any value within the aforementioned 1 ppm to 10 ppm), preferably about 4 ppm to about 8 ppm; a concentration of polyethyleneimine is about 1 ppm to about 10 ppm (exemplified as 1 ppm, 2 ppm, 4 ppm, 6 ppm, 8 ppm, 10 ppm or any value within the aforementioned 1 ppm to 10 ppm), preferably about 3 ppm to about 6 ppm.

When the additive is added into the electrolyte, it may enable the electrolytic copper foil produced by the manufacturing method of the electrolytic copper foil to maintain good high strength and elongation even after high-temperature treatment.

In this embodiment, the electroplating to form the electrolytic copper foil may be performed under the following conditions: a plating solution temperature may be about 50° C. to about 70° C. (exemplified as 50° C., 55° C., 60° C., 65° C., 70° C. or any value within the aforementioned 50° C. to 70° C.), preferably about 50° C. to about 60° C.; a current density may be about 40 ASD to about 60 ASD (exemplified as 40 ASD, 45 ASD, 50 ASD, 55 ASD, 60 ASD or any value within the aforementioned 40 ASD to 60 ASD), preferably about 50 ASD to about 60 ASD.

A time of the electroplating is not particularly limited, and suitable time may be selected according to needs. For example, the electroplating may be performed until an electrolytic copper foil with a thickness of about 3 μm to 8 μm formed on a surface of the cathode before stopping.

The manufacturing method of the electrolytic copper foil may further include: removing the electrolytic copper foil from the surface of the cathode, washing with water, soaking in chromic acid, washing with water again, and then drying. A concentration of chromic acid may be about 1.0 g/L to 2.5 g/L (exemplified as 1.0 g/L, 1.5 g/L, 2.0 g/L, 2.5 g/L or any value within the aforementioned 1.0 g/L to 2.5 g/L), preferably about 1.5 g/L to about 2.0 g/L.

In this embodiment, the thickness of the electrolytic copper foil produced by the aforementioned manufacturing method of the electrolytic copper foil may be about 3 μm to about 8 μm (exemplified as 3 μm, 4 μm, 6 μm, 8 μm or any value within the aforementioned 3 μm to 8 μm), preferably about 6 μm to about 8 μm. A roughness of the electrolytic copper foil may be about 1.4 μm to about 4.3 μm (exemplified as 1.4 μm, 2 μm, 3 μm, 4.3 μm or any value within the aforementioned 1.4 μm to 4.3 μm), preferably about 1.4 μm to about 2.0 μm.

After heat treatment at a temperature of about 180° C. to about 200° C. for about 1 hour to about 2 hours, a tensile strength of the electrolytic copper foil may be about 34 kg/mm² to about 58 kg/mm² (exemplified as 34 kg/mm², 40 kg/mm², 50 kg/mm², 58 kg/mm² or any value within the aforementioned 34 kg/mm² to 58 kg/mm²), preferably about 46 kg/mm² to about 58 kg/mm²; an elongation of the electrolytic copper foil may be about 3.3% to about 4.2% (exemplified as 3.3%, 3.5%, 4.0%, 4.2% or any value within the aforementioned 3.3% to 4.2%), preferably about 3.6% to about 4.2%. After high-temperature treatment, the electrolytic copper foil may maintain good high strength and elongation, and thus may be suitable for components/devices such as current collectors that are produced through high-temperature treatment.

An exemplary embodiment of the invention provides a current collector including the electrolytic copper foil above. In this embodiment, the current collector may be a lithium battery negative electrode current collector. Since the thickness of the electrolytic copper foil may be about 3 μm to about 8 μm, when applied to a negative electrode current collector for lithium batteries, it may reduce the volume and/or lower the weight of the lithium battery, thereby achieving the lightweight requirements of lithium batteries.

Hereinafter, the invention will be described in detail with reference to examples. The following examples are provided to describe the invention, and the scope of the invention includes the scope described in the following claims and their substitutions and modifications, and is not limited to the scope of the examples.

### Examples of Manufacturing Method of Electrolytic Copper Foil and Electrolytic Copper Foil Manufactured Thereof

Examples 1 to 9 and Comparative Example 1 of the manufacturing method of electrolytic copper foil are described below:

### Example 1

Using a titanium wheel as the cathode and iridium titanium oxide (IrO₂/Ti) as the anode, a copper sulfate plating solution (with a copper sulfate concentration (copper ion concentration) of about 60 mg/L, a sulfuric acid concentration of about 80 mg/L, and a chloride ion concentration of about 30 ppm in the plating solution) is used. Under conditions where the temperature of the plating solution is about 50° C., the current density is about 60 ASD, and the rotation speed of the titanium wheel is about 800 rpm, 5 ppm of hydroxyethyl cellulose (HEC) is added into the electrolyte, then the electroplating is performed until an electrolytic copper foil with a thickness of about 6 μm is formed. After removing the electrolytic copper foil from the surface of the titanium wheel, it is washed with water, soaked in chromic acid, washed with water again, and then dried.

### Example 2 to Example 9 and Comparative Example 1

The manufacturing method of an electrolytic copper foil of Example 2 to Example 9 and Comparative Example 1 are prepared using the same steps as in Example 1, and the differences therebetween is: changing the composition types and usage amount thereof of the electrolyte and the additive (as shown in Table 1). The resulting electrolytic copper foils are evaluated using the following evaluation methods, and the results are shown in Table 1.

TABLE 1

Example

| Composition | | | 1 | 2 | 3 | 4 | 5 |
|---|---|---|---|---|---|---|---|
| Electrolyte | Copper sulfate (mg/L) | | 60 | 60 | 60 | 60 | 60 |
| | Sulfuric acid (mg/L) | | 80 | 80 | 80 | 80 | 80 |
| | Chloride ion (ppm) | | 30 | 30 | 30 | 30 | — |
| Additive | Hydroxyethyl cellulose | | 5 | — | — | — | — |
| | Sodium 3-mercapto-1- | | — | 5 | — | — | — |
| | propanesulfonate | | | | | | |
| | Ethylene thiourea | | — | — | 5 | — | — |
| | Bio-glue | | — | — | — | 5 | — |
| | Polyethyleneimine | | — | — | — | — | 6 |
| Evaluation | Roughness (μm) | | 4.3 | 2.9 | 2.7 | 4.0 | 1.8 |
| result | Tensile | Before heat treatment | 42 | 33 | 49 | 38 | 62 |
| | strength | After heat treatment | 46 | 35 | 45 | 34 | 52 |
| | (kg/mm²) | | | | | | |
| | Elongation | Before heat treatment | 3.4 | 3.2 | 3.1 | 3.2 | 3.6 |
| | (%) | After heat treatment | 3.3 | 3.3 | 3.5 | 4.2 | 3.9 |

| | | | | | | | Comparative |
|---|---|---|---|---|---|---|---|
| | | | Example | | | | Example |
| Composition | | | 6 | 7 | 8 | 9 | 1 |
| Electrolyte | Copper sulfate (mg/L) | | 60 | 60 | 60 | 60 | 60 |
| | Sulfuric acid (mg/L) | | 80 | 80 | 80 | 80 | 80 |
| | Chloride ion (ppm) | | 30 | 30 | 30 | 30 | 30 |
| Additive | Hydroxyethyl cellulose | | — | 4 | — | 4 | — |
| | Sodium 3-mercapto-1- | | 6 | 6 | 6 | 6 | — |
| | propanesulfonate | | | | | | |
| | Ethylene thiourea | | — | 5 | 5 | 5 | — |
| | Bio-glue | | — | — | 8 | 8 | — |
| | Polyethyleneimine | | 6 | — | — | — | — |
| Evaluation | Roughness (μm) | | 1.4 | 2.0 | 2.5 | 1.5 | 4.8 |
| result | Tensile | Before heat treatment | 60 | 55 | 54 | 57 | 35 |
| | strength | After heat treatment | 58 | 44 | 47 | 55 | 31 |
| | (kg/mm²) | | | | | | |
| | Elongation | Before heat treatment | 3.3 | 3.1 | 3.8 | 3.3 | 2.8 |
| | (%) | After heat treatment | 3.7 | 3.6 | 4.2 | 3.6 | 4.4 |

*Heat treatment is performed at a temperature of about 190° C. for about 1 hour.

### <Evaluation Method>

Roughness: The roughness test of the electrolytic copper foil is performed using a laser scanning confocal microscope by measuring the intensity of reflected laser light. When the roughness is smaller, it shows that the electrolytic copper foil has good surface smoothness.

Tensile strength: The tensile strength test of the electrolytic copper foil is performed using a tensile testing machine according to the engineering stress-engineering strain curve. When the tensile strength is larger, it shows that the electrolytic copper foil has good ability to withstand stress during processing, i.e., good mechanical strength, and thus not easily fractured.

Elongation: The elongation test of the electrolytic copper foil is performed using a tensile testing machine according to the engineering stress-engineering strain curve. When the elongation is larger, it shows that the electrolytic copper foil has good ability to withstand volume changes during processing, i.e., good mechanical strength, and thus not easily fractured.

### <Evaluation Result>

It may be seen from Table 1 that when the manufacturing method of an electrolytic copper foil includes adding an additive into the electrolyte, and the additive include hydroxyethyl cellulose, sodium 3-mercapto-1-propanesulfonate, ethylene thiourea, bio-glue, polyethyleneimine or a combination thereof (Examples 1 to 9), the electrolytic copper foil produced by the manufacturing method thereof has small roughness, high tensile strength and high elongation, i.e., good surface smoothness and mechanical strength. In contrast, the electrolytic copper foil formed by Comparative Example 1, where the manufacturing method does not include adding specific additives into the electrolyte, has high roughness, low tensile strength and low elongation, i.e., poor surface smoothness and mechanical strength.

Furthermore, after heat treatment at about 190° C. for about 1 hour, the electrolytic copper foil (Examples 1 to 9) produced by the manufacturing method therefore adding specific additive into the electrolyte has high tensile strength and high elongation, i.e., good thermal stability and maintained good mechanical strength. In contrast, the electrolytic copper foil (Comparative Example 1) produced by the manufacturing method without adding specific additive into the electrolyte shows low tensile strength and low elongation after heat treatment, i.e., poor mechanical strength.

Moreover, compared to the electrolytic copper foil produced by the manufacturing method thereof adding only one type of additive (Examples 1 to 5), the electrolytic copper foil produced by the manufacturing method thereof adding two or more types of additives (Examples 6 to 9) has smaller roughness, i.e., better surface smoothness, and may have good mechanical strength both before and after heat treatment.

In summary, when the manufacturing method of an electrolytic copper foil of the present invention includes adding an additive into the electrolyte, and the additive includes hydroxyethyl cellulose, sodium 3-mercapto-1-propanesulfonate, ethylene thiourea, bio-glue, polyethyleneimine or a combination thereof, the manufactured electrolytic copper foil may have good surface smoothness and mechanical strength, and may have good thermal stability to maintain good mechanical strength after heat treatment. Therefore, it may be applied to current collectors such as negative electrode current collectors for lithium batteries, and thus, have good applicability.

Although the present invention has been disclosed above through embodiments, they are not intended to limit the present invention. Anyone with ordinary knowledge in the relevant technical field may make some changes and modifications without departing from the spirit and scope of the present invention. Therefore, the protection scope of the present invention shall be determined by the appended patent application scope.

What is claimed is:

1. A manufacturing method of an electrolytic copper foil, comprising:
providing an electrolytic device comprising a cathode and an anode;
soaking the cathode in an electrolyte;
adding an additive into the electrolyte; and
performing electroplating to form an electrolytic copper foil on a surface of the cathode,
wherein the additives comprise hydroxyethyl cellulose, sodium 3-mercapto-1-propanesulfonate, ethylene thiourea, bio-glue, polyethyleneimine or a combination thereof.

2. The manufacturing method of an electrolytic copper foil according to claim 1, wherein in the electrolyte, a concentration of the additive is 1 ppm to 25 ppm.

3. The manufacturing method of an electrolytic copper foil according to claim 1, wherein in the electrolyte, a concentration of hydroxyethyl cellulose is 1 ppm to 10 ppm, a concentration of sodium 3-mercapto-1-propanesulfonate is 1 ppm to 10 ppm, a concentration of ethylene thiourea is 1 ppm to 10 ppm, a concentration of bio-glue is 1 ppm to 10 ppm, and a concentration of polyethyleneimine is 1 ppm to 10 ppm.

4. The manufacturing method of an electrolytic copper foil according to claim 1, wherein the electrolyte is a copper sulfate plating solution, in the copper sulfate plating solution, a concentration of copper ions is 60 g/L to 80 g/L, a concentration of sulfuric acid is 60 g/L to 110 g/L.

5. The manufacturing method of an electrolytic copper foil according to claim 4, wherein the copper sulfate plating solution further comprises chloride ions with a concentration of 5 ppm to 30 ppm.

6. The manufacturing method of an electrolytic copper foil according to claim 1, wherein the cathode is a titanium wheel, the anode is iridium titanium oxide (IrO₂/Ti), and a rotation speed of the titanium wheel is 500 rpm to 1000 rpm.

7. The manufacturing method of an electrolytic copper foil according to claim 1, wherein the electroplating is performed under the following conditions: a plating solution temperature is from 50° C. to 70° C., and the current density is from 40 ASD to 60 ASD.

8. An electrolytic copper foil manufactured by the manufacturing method of an electrolytic copper foil according to claim 1.

9. The electrolytic copper foil according to claim 8, wherein a thickness of the electrolytic copper foil is 3 μm to 8 μm.

10. The electrolytic copper foil according to claim 8, wherein a roughness of the electrolytic copper foil is 1.4 μm to 4.3 μm.

11. The electrolytic copper foil according to claim 8, wherein after heat treatment at 180° C. 10 to 200° C. for 1 hour to 2 hours, a tensile strength of the electrolytic copper foil is 34 kg/mm² to 58 kg/mm², an elongation of the electrolytic copper foil is 3.3% to 4.2%.

12. A current collector, comprising: the electrolytic copper foil according to claim 8.
